(19) United States
(12) Patent Application Publication
(10) Pub. No.: US 2013/0290022 A1
(43) Pub. Date: Oct. 31, 2013

(54) SYSTEM AND METHOD FOR CREATING METADATA-BASED NATURAL LANGUAGE PROCESSING CAPABILITIES

(71) Applicant: Shahid N. Shah, Silver Spring, MD (US)

(72) Inventor: Shahid N. Shah, Silver Spring, MD (US)

(73) Assignee: NETSPECTIVE COMMUNICATIONS LLC, Silver Spring, MD (US)

(21) Appl. No.: 13/457,782

(22) Filed: Apr. 27, 2012

(51) Int. Cl. G06Q 50/24

(52) U.S. Cl. 705/3

(57) ABSTRACT

A system and method for managing data in a healthcare environment can include a content based router, and a healthcare record bank. The content based router can be configured to collect the data from a clinical data provider and convert the data in a format in accordance with a defined standard. The healthcare record bank can include or be coupled to a data repository. The healthcare record bank can be configured to be coupled to the clinical data provider through the content based router over a communication network. The healthcare record bank can be configured to store the data received from the clinical data provider and can be accessible or searchable from within or outside the healthcare record bank. The healthcare record bank can be coupled to or include a data logging unit configured to maintain metadata associated with the clinical data and configured to facilitate natural language processing capabilities.

### BACKGROUND

1. Technical Field

The embodiments herein generally relate to data management, and, more particularly, to healthcare date management systems and methods.

2. Description of the Related Art

Hospitals, caretakers, nursing centers or homes, medical offices, medical centers, or other sources of medical care generally keep medical and demographic or other such records of their patients. These records may include a variety of information such as demographic information of their patients, medical history, diagnostic and pathology reports of their patients, medical reports or prescriptions, or other such information. This information can be used for a variety of purposes by these sources of medical care. A few examples of them are, without limitations, tracking of the patients and their records, billing, historical assessments, future care taking, proper ongoing medical or health assessment or treatment, or any other similar purpose.

The medical sources may require collecting data from several sources to be stored in a central repository. The data obtained from these varied sources may exist in different formats and may not be standardized in accordance with a defined format. This may cause difficulty in handling of the data by the medical sources resulting in mismanagement, data leakage, data loss, data asynchronization, or any other such loss.

Additionally, searching the data or a specific portion of the data may be difficult in cases where the data exists in a non-standardized manner. Particularly, searching for the data from within the metadata may be extremely difficult from within the medical source or from outside.

In light of the above, there is a need of a system and a method configured to retrieve data from varied medical sources and convert it in a standardized format before storing into a data bank of a medical source. There is also a need of a system and a method configured to provide a natural language capability operable on the metadata of the data and making searching of the data from within the medical source or from outside possible and easy.

### SUMMARY

In view of the foregoing, an embodiment herein provides a system for managing data in a healthcare environment. The system can include a proxy database, a content based router, and a healthcare record bank. The proxy database can be configured to create a backup of data associated with a clinical data provider. The content based router can be configured to collect the data from the proxy database and convert the data in a format in accordance with a defined standard. The healthcare record bank can include or being coupled to a data repository. The healthcare record bank can be configured to be coupled to the clinical data provider through the content based router over a communication network. The healthcare record bank can be configured to store the data received from the clinical data provider and can be accessible or searchable from within or outside the healthcare record bank. The healthcare record bank can be coupled to or include a data logging unit configured to maintain a metadata associated with the clinical data and configured to facilitate natural language processing (NLP) capabilities.

Another embodiment provides a system for managing data in a healthcare environment. The system can include a content based router, and a healthcare record bank. The content based router can be configured to collect the data from a clinical data provider and convert the data in a format in accordance with a defined standard. The healthcare record bank can include or being coupled to a data repository. The healthcare record bank can be configured to be coupled to the clinical data provider through the content based router over a communication network. The healthcare record bank can be configured to store the data received from the clinical data provider and can be accessible or searchable from within or outside the healthcare record bank. The healthcare record bank can be coupled to or include a data logging unit configured to maintain a metadata associated with the clinical data and configured to facilitate natural language processing (NLP) capabilities.

Another embodiment provides a method for managing data in a healthcare environment. The method can include creating a backup of data associated with a clinical data provider in a proxy database. The method can include using a content based router to collect the data from the proxy database and convert the data in a format in accordance with a defined standard. The method can include maintaining a metadata associated with the clinical data in a data logging unit, and providing natural language processing (NLP) capabilities for searching the metadata.

Another embodiment provides a computer program product for managing the data in a healthcare environment. The computer program product can include a computer-readable storage medium, and a computer-readable program code means embodied in the computer-readable storage medium. The computer-readable program code means can include a first computer-readable program code means for creating a backup of the data associated with a clinical data provider in a proxy database. The computer-readable program code means can include a second computer-readable program code means for using a content based router to collect the data from the proxy database and convert the data in a format in accordance with a defined standard. The computer-readable program code means can include a third computer-readable program code means for maintaining a metadata associated with the clinical data in a data logging unit. The computer-readable program code means can include a fourth computer-readable program code means for providing natural language processing (NLP) capabilities for searching the metadata.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram illustrating a high level system architecture according to an embodiment herein;

FIG. 2 is a block diagram illustrating a functional overview of the system architecture of FIG. 1 according to an embodiment herein;

FIG. 3 is a flow chart illustrating a method of creating natural language based data processing capabilities from metadata facilitated by proxy database drivers according to an embodiment herein; and

FIG. 4 is a block diagram illustrating a computer system according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

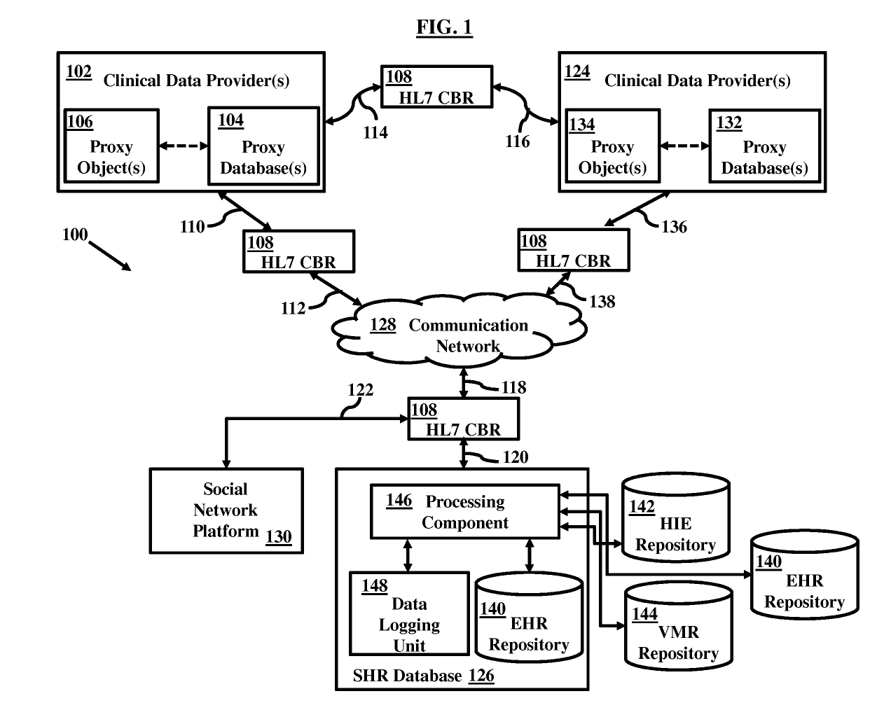

The embodiments herein provide a system and method of healthcare data management by creating metadata-based natural language processing capabilities. Referring now to the drawings, and more particularly to FIGS. 1 through 4, where similar reference characters denote corresponding features consistently throughout the figures, there are shown preferred embodiments.

FIG. 1 illustrates generally, but not by the way of limitation, among other things, an example of a high level system architecture 100 according to an embodiment herein. The architecture 100 can include a Social Healthcare Database (SHRDB 126) to manage metadata information from a plurality of clinical data providers through an HLR Content Based Router (CBR) 108. The SHRDB 126 can be configured to create natural language data processing capabilities in accordance with the defined metadata information over a communication network 128.

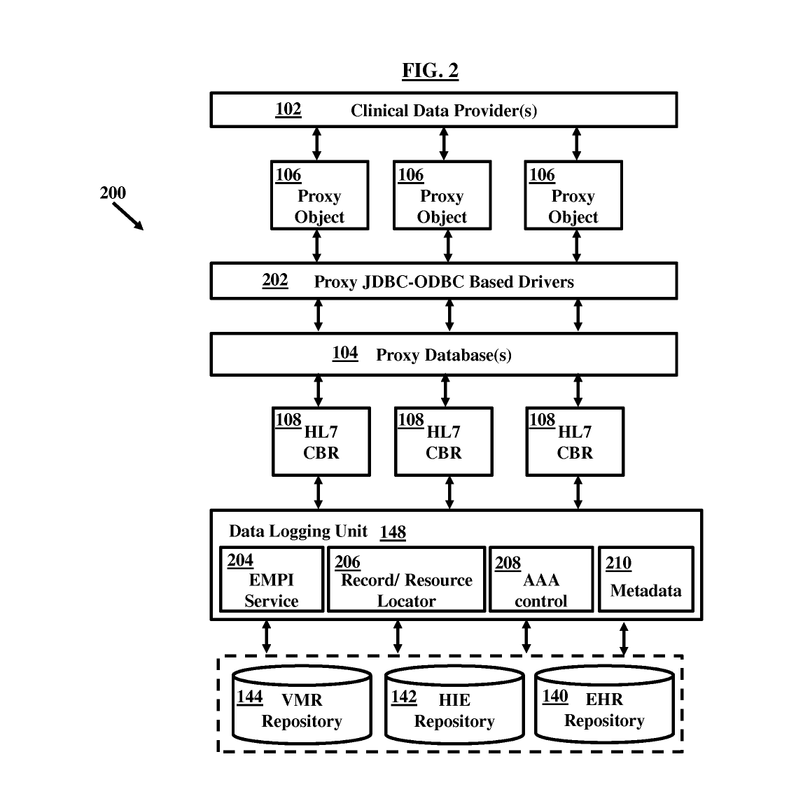

In particular, as shown in FIG. 1, a clinical data provider 102 can, for example, be a hospital, a clinic, a medical organization, a physician's office, etc. As shown in FIG. 1, the clinical data provider 102 can include internal systems (which can, for example, include database or possess data storage capabilities). The clinical data provider 102 can be configured to interact with a proxy database 104 to backup the data related to the clinical data provider 102. The clinical data provider 102 can backup the data on the proxy database 104 through the one or more proxy objects 106. The one or more proxy objects 106 may include references to the proxy database 104 to establish a connection between the clinical data provider 102 and the proxy database 104 through the database drivers. These database drivers can be explained in more details in conjunction with FIG. 2. The data described herein can be for example, but is not limited to, doctor's visits, lab tests, hospital stays, clinical trials, patient problems, patient health information, patient habits, patient medical history, patient appointments, patient medical insurance, patient medical bills and related status, or any other data.

A Health Level 7 (HL7) Content Based Router (CBR) 108 can be employed that is associated with a database or data storage facility or capability, and can include a local internal interface to handle direct links such as 110, 112, 114, 116, 118, 120, or 122 to communicate with other nodes such as the clinical data providers 102, and 124, and the SHRDB 126 over the communication network 128. In an example, the HL7 CBR 108 can be situated at a gateway of the organization such as the clinical data providers 102, 124, a network platform 130, or the SHRDB 126 to communicate among each other over the communication network 128. In some embodiments, several HL7 CBRs similar to the HL7 CBR 108 can be situated at more than one or each of the gateways. For example, three such HL7 CBRs 108 are shown in the FIG. 1. In an example, a respective HL7 CBR 108 can be configured to be situated at the clinical data providers 102, 124 endpoints, the network platform 130 endpoints, or the SHRDB 126 endpoints to communicate amongst each other over the communication network 128. In some embodiments, only one common HL7 CBR 108 may be configured at the endpoint or gateway of the SHRDB 126, such that the SHRDB 126 can exchange, integrate, share, receive or provide data to or from the nodes such as the one or more clinical data providers 102, 124, or the social network platform 130, or any other node. The HL7 CBR 108 can be configured to collect data from the one or more proxy databases such as the proxy database 104 and 132. The HL7 CBR 108 can be configured to convert the data in a common format such as in accordance with the HL7 standard such that the data within the communication network 128 between the HL7 CBR 108 may comply with the common format and is validated according to a single standard or mechanism such as the HL7 standard. The HL7 standard described herein may provide a framework for the exchange, integration, sharing, or retrieval of health information from or to the SHRDB 126. In an example, the HL7 standard can also be used to refer to some of the specific standards such as HL7 v2.x, v3.0, HL7 Reference Information Model (RIM), etc. created by the organization such as the clinical data providers 102 and 124, the social network platform 130, or the SHRDB 126.

In an example, the clinical data providers 102 may interact with other clinical data providers 124 through the HL7 CBR 108 to exchange data amongst each other. The clinical data provider 124 described herein can be configured to include a proxy database 132 to backup clinical data associated with the clinical data provider 124. The clinical data provider 124 can be configured to include one or more proxy objects 134 to backup data on the proxy database 132. The one or more proxy objects 134 described herein may include references to the proxy database 132 to establish a connection among the clinical data provider 124 and the proxy database 132 through the database drivers. The proxy database 132 can be configured to interact with the HL7 CBR 108 through the direct links such as 114, 116, 118, 120, 122, 136, or 138 to communicate with other nodes such as other content service providers 102, and the SHRDB 126 over the communication network 128.

The communication network 128 described herein can be configured to provide a communicative interconnection of various nodes such as the clinical data providers 102, 124, the SHRDB 126, social network platform 130, or any other node in the communication network 128. The communication network 128 can be configured to facilitate the various nodes to exchange, integrate, share, receive or provide data among each other, in accordance with the HL7 standard facilitated by the respective HL7 CBR 108 (may be configured at the endpoint or at the gateway of the organization). The communication network 128 may be a wireless communications network or a wire line communications network. The wireless communications network may be for example, but not limited to, a digital cellular network, such as Global System for Mobile Telecommunications (GSM) network, Personal Communication System (PCS) network, or any other wireless communications network. The wire line communications network may be for example, but not limited to, a Public Switched Telephone Network (PSTN), proprietary local and long distance communications network, or any other wire line communications network. One or more networks may be included in the communication network 128 and may include both public networks such as the Internet, and private networks and may utilize any networking technology and protocol, such as Ethernet, Token Ring, Transmission Control Protocol/Internet Protocol (TCP/IP), or the like to allow interaction among various nodes such as the clinical data providers 102, 124, the SHRDB 126, social network platform 130, or any other node in the network.

In an example, where a single and common HL7 CBR 108 may be provided at the gateway of the SHRDB 126, the communication network 128 may be configured to translate or convert the data at the common HL7 CBR 108 to exchange, integrate, share, receive, or provide data to or from the various nodes connected with the communication network 128. The common HL7 CBR 108 may comply with the common data format and may be validated according to the single standard or mechanism such as the HL7 standard, for example when information first enters the SHRDB 126.

The SHRDB 126, described herein, may be centralized or decentralized. The SHRDB 126 may store the data provided by the plurality of clinical data providers in an electronic healthcare (EHR) repository 140. The SHRDB 126 may communicate with different nodes such as the clinical data providers 102, 124, the social network platform 130, EHR repository 140, Health Information Exchange (HIE) repository 142, Virtual Medical Records (VMR) repository 144, etc. to exchange, integrate, share, receive, or provide data through the HL7 CBR 108. The EHR repository 140 can store the data such as electronic healthcare records. The data can be organized in a way that facilitates local or remote information management in the communication network 128 through a processing component 146. In some embodiments, the processing component 146 may be, but is not limited to, a microprocessor, a microcontroller, or the equivalent. The processing component 146 may be capable of executing instructions to process data over the communications network 128. The data corresponding to a particular user may or may not have been derived from medical testing or treatment (e.g., the data may have been derived from a research organization trial in which an individual voluntarily participated or data may have been derived from insurance services or any other source).

More generally, the SHRDB 126 may also include data related to different electronic sources such as doctor's visits, lab tests, hospital stays, clinical trials, patient problems, patients' health information, patient habits, patient medical history, patient appointments, patient medical insurance, patient medical bills status, or any other information. The SHRDB 126 may include or be coupled to other electronic data sources such as the HIE repository 142 and the VMR repository 144 to dynamically manage information related to or from the electronic sources. The HIE repository 142 may include electronic healthcare information related to a region, community, or hospital system. In examples, the HIE repository 142 may provide additional storage, retrieval, and manipulation of health information such that the SHRDB 126 can dynamically mange EHR data through the HL7 CBR 108. The VMR repository 144 described herein may store data related to the electronic medical information or other sources. The virtual medical records, described herein, may be a simplified, standardized electronic health record data designed to support interfacing to the SHRDB 126. The SHRDB 126 may include or be coupled to a data logging unit 148. The data logging unit 148 can be configured to receive the data from the proxy databases 106 and 134 through the HL7 CBR 108. The HL7 CBR 108 can be configured to translate or convert the data moving to or coming from the proxy database such as 106 or 134. Natural Language Processing (NLP) capabilities can be created, in accordance with metadata learned from the database drivers. Additional details about the data logging unit 148 is explained in conjunction with FIG. 2 and described below.

The description provided above includes proxy objects such as 106 and 134, and proxy databases such as 104 and 132, in accordance with some examples, however, it should be appreciated that there can be other techniques used by those skilled in the art that can be embodied without using proxy objects and the proxy databases.

FIG. 2, with reference to FIG. 1, illustrates generally, but not by the way of limitation, among other things, a functional overview of the system 200 as described in FIG. 1, in accordance with the embodiments herein. The clinical data provider 102 can be configured to backup data on the proxy database 104. The clinical data provider 102 can be configured to connect to the proxy database 104 to backup the data on the proxy database 104. In an example, the clinical data provider 102 may not directly connect to the proxy database 104 to avoid security problems. Therefore, the clinical data provider 102 can be configured to use the one or more proxy objects 106 to connect to the proxy database 104.

The clinical data provider 102 can be configured to establish a connection to communicate with the proxy database 104. The clinical data provider 102 may implement a common set of routines (such as classes) to connect to the proxy database 104 through proxy JDBC-ODBC drivers (Java Database Connectivity and Open Database Connectivity Drivers) 202. The JDBC-ODBC database drivers 202 described herein are only for illustrative purposes, and the embodiments herein are not limited to these types of drivers. In some embodiments, there may be other database drivers such as MySQL®, Oracle®, or any other database driver to connect to the proxy database 104. In some examples, other drivers or interfaces such as database interfaces or frameworks may also be employed. The connection with the proxy database 104 may be established by loading a class of appropriate proxy JDBC-ODBC drivers 202. The system 200 can be configured to allow the clinical data provider 104 to create the one or more proxy objects 106 whose functions can be mirrored with the functions of the proxy Java Database Connectivity (JDBC) objects created on the proxy database 104. The clinical data provider 102 may then use these proxy objects 106 to communicate with the proxy database 104. This may result in creating a session on the clinical data provider 102 for each call to a DriverManager.connect( ) object. This object may be the proxy for the actual session object on the proxy database 104, used later to execute methods to backup data and create statements on the proxy database 104. An example using such proxy JDBC-ODBC Driver 202 is shown in the code below:

```
// creates a connection object on the proxy databaseConnection
con=JDBCDriver.connect(“jdbc:odbc:Database”);//
Load the proxy database drivers
  Class.forName( “sun.jdbc.odbc.JdbcOdbcDriver”) ;
  // Get a connection to the proxy database through the proxy database
  drivers
  Connection con =
  DriverManager.getConnection( “jdbc:odbc:Database”);
```

In an example, a batch of data may be sent through the clinical data provider 102 to backup on the proxy database 104. The call to the proxy database 104 by the clinical data provider 102 may be batched for better performance. The batch of statements (such as including queries to backup the data on the proxy database 104) may be sent to the proxy database 104. The proxy database 104 may execute the batch of statements in sequence, parallel, or a combination thereof. In an example, the proxy database 104 may return a result set such as a unique name of the proxy object 102 (e.g., Connection, Statement, Prepared Statement etc.) created on the proxy database 104. In an example, the proxy database 104 may execute the batch of statements and return the result set such as a null object. In an example, one or more exceptions thrown by the proxy database 104 may be serialized and may be sent to the clinical data provider 102 (if exceptions occur). If the execution of the statements results in creating one or more new proxy objects on the proxy database 104, then the unique name of the one or more proxy objects is returned to the clinical data provider 102 (for use to later connect and backup the data). In an example, the clinical data provider 102 may override the finalize( ) method, such as the proxy object 106 may be garbage collected (by the use of finalize( ) method) on the clinical data provider 102. In an example, the actual proxy objects 102 may also be removed from the proxy database 104 and may also be garbage collected (upon overriding the finalize( )method). An example using such batch processing is shown below as a piece of code.

// creates a Connection object on the proxy database
Connection connection=JDBCDriver.connect(“jdbc:odbc:Database”);
// -start batch
PreparedStatementps=connection.PrepareStatement(String);
ps.setString(1, String);
ps.setInt(2, int);
ps.setDate(3, Date);
ResultSetrset=(ResultSet)ps.executeQuery( );
//- end batch

The proxy database 104 may then interact with the respective HL7 CBR 108 to convert or translate the data into a common format such as the HL7 standard and provide the converted or translated data to the SHRDB 126. In an example, the HL7 CBR 108 may be configured to implement data correlation technology such that the data can be integrated into a common format. The SHRDB 126 can be configured to include the data logging unit 148. The data logging unit 148 can be configured to track a unique network identifier associated with the HL7 CBR 108 such that the data or piece of information received from the respective HL7 CBR 108 can be uniquely identified through a local identifier associated with the data. The data logging unit 108 can be configured to maintain an Enterprise Master Patient Index (EMPI) service 204, a Record or Resource Locater Service 206, an AAA (Authentication, Authorization, Accounting) 208 or security technologies (for e.g., to store or track current or past data or authorizations provided by, or on behalf of, or relating to different clinical data providers), a metadata management service 210 to facilitate the NLP capabilities such as for example the metadata learned from the proxy database drivers 202.

The EMPI service 204 can be configured to manage the patient's identifier from the respective HL7 CBR 108, EHR repository 142, HIE repository 144, or VMR repository 144 to help it identify and locate appropriate records data. The information about the EMPI 204 is configured to define, use, interpret, and normalize the metadata 210 across the system 200. In an example, a common metadata configuration can be maintained by the data logging unit 148 for the data received from the respective HL7 CBR 108. Further, the data logging unit 148 can be configured to maintain a common way to represent the HL7 CBR 108 data (from a plurality of proxy databases similar to the proxy database 102 and 124) in a metadata store. Each of the HL7 CBRs 108 in the communication network 128 can be configured to describe certain information to define metadata, which can be configured during deployment of the HL7 CBR 108. In an example, the data logging unit 148 can be configured to populate the metadata store in accordance with each HL7 CBR identifier such as name, ID, or any other mechanism that can uniquely identify the data provided by each HL7 CBR 108. In an example, the data logging unit 148 can be configured to maintain the metadata configuration in accordance with the HL7 CBR identifier.

An example of such metadata can be Title: metadata HL7 CBR, Identifier: govhealthcare.com, format: HL7 Standard, provider: clinical data provider, connection: proxy database drivers.

The data logging unit 148 can be configured to facilitate an XML search structure to provide NLP capabilities over the communication network 128. In an example, the data logging unit 148 may be configured to define the metadata using the Get( ) method from the HL7 CBR 108 and provide the data to the HL7 CBR 108 using the Put( ) method. In an example, the metadata is defined from the proxy database drivers 202 such as shown in the code below:

classJDBCProxyDatabaseMetaDataExample
// Createa connection object on the proxy database
Connection con=JDBCDriver.connect(“jdbc:odbc:Database”);
// Load the proxy database drivers
Class.forName( “sun.jdbc.odbc.JdbcOdbcDriver” ) ;
// Get a connection to the proxy database through the proxy database
drivers
Connection con =
DriverManager.getConnection( “jdbc:odbc:Database”)
//Metadata configuration data retrieval from the proxy database drivers
DatabaseMetaDatametaData = con.getMetaData( )
ResultSetrs = metaData.getTypeInfo( );
//Query statements for metadata information from the proxy database
drivers
ResultSetresultSet = st.executeQuery(“SELECT * FROM
proxydatabase”);
ResultSetMetaData md = resultSet.getMetaData( );

In an example, the data logging unit 148 can be configured to deploy the metadata configuration as a separate schema into either a directly attached SHRDB 126 or shared data repositories such as the HIE repository 142 or the VMR repository 144 supported by an overall SHRDB 126 deployment. The SHRDB 126 can be configured to provide NLP capabilities, in accordance with the defined metadata configuration learnt from the proxy database drivers 202 and the respective HL7 CBR 108.

In an example, the system 200 as described above can be configured to support various languages such that the system 200 can be configured to search for data and extract information or the data irrespective of the language of the metadata contained therein. In an example, the system 200 can be configured to check for security such as monitoring for data leakage.

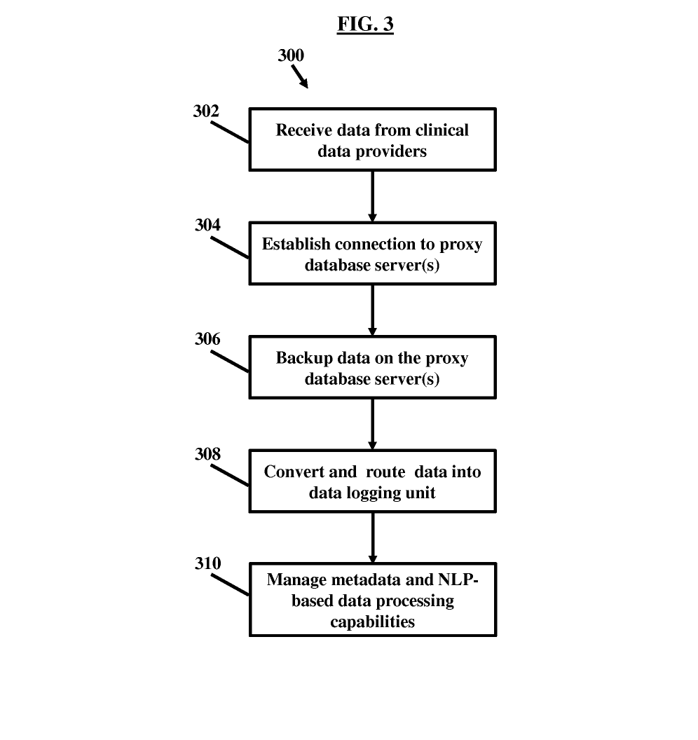

FIG. 3, with reference to FIGS. 1 and 2, illustrates generally, but not by the way of limitation, a flow chart depicting a method 300 for creating natural language based data processing capabilities from metadata facilitated by the proxy database drivers 202, according to an embodiment herein. At step 302, the method 300 may receive data from clinical data providers such as the clinical data provider 102. At step 304, the clinical data provider 102 can establish a connection with the proxy database 104 using the proxy database drivers 202. At step 306, the clinical data provider 102 may backup the data on the proxy database 104. At step 308, the method 300 may allow the HL7 CBR 108 to convert or translate the data into a common format such as HL7 standard. The method 300 may allow the HL7 CBR 108 to route the data into the data logging unit 148. At step 310, the data logging unit 148 can manage the metadata learnt from the proxy database drivers 202 such that the SHRDB 126 creates NLP-based data processing capabilities, in accordance with the defined metadata configurations.

The embodiments herein may be embodied as a computer program product configured to include a pre-configured set of instructions, which when performed, can result in actions as stated in conjunction with the method 300 and described above. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may also include tangible and/or non-transitory computer-readable storage media for carrying or having computer executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium.

Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

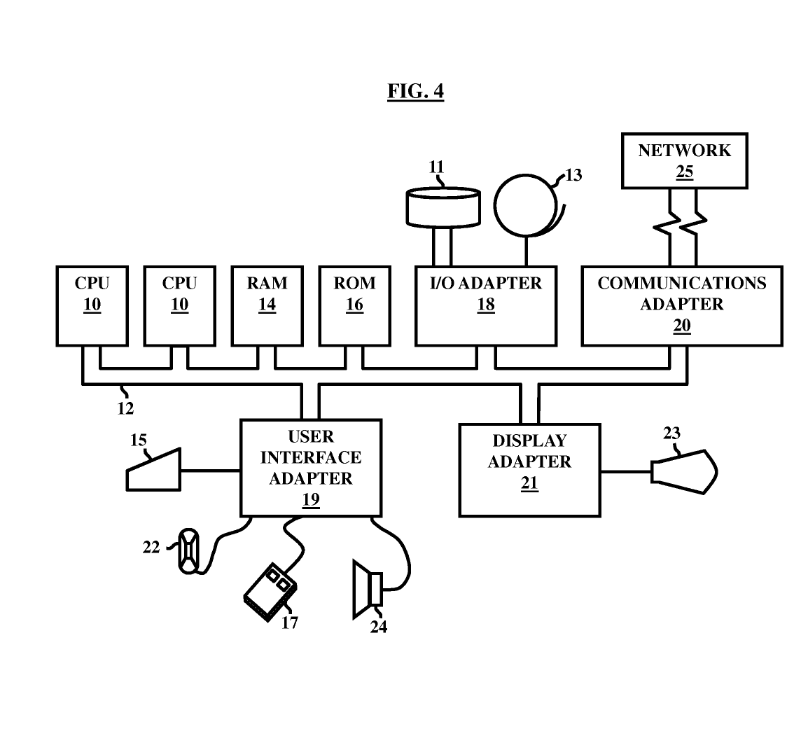

A representative hardware environment for practicing the embodiments herein is depicted in FIG. 4. This schematic drawing illustrates a hardware configuration of an information handling/computer system in accordance with the embodiments herein. The system comprises at least one processor or central processing unit (CPU) 10. The CPUs 10 are interconnected through system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

In the above detailed description, reference is made to the accompanying drawings, which form a part hereof, and that is shown by way of illustrating specific examples. The examples can be combined, or that other examples can be utilized and that structural, logical, and electrical changes can be made. The above detailed description is, therefore, not to be taken in a limiting sense, and the scope of the invention is defined by the appended claims and their equivalents.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for managing data in a healthcare environment, said system comprising:
a proxy database that creates a backup of data associated with a clinical data provider;
a content based router that:
collects said data from said proxy database; and
converts said data in a format in accordance with a defined standard;
a data repository operatively connected to said content based router;
a healthcare record bank coupled to said data repository, wherein said healthcare record bank is coupled to said clinical data provider through said content based router over a communication network, wherein said healthcare record bank stores said data received from the clinical data provider and is accessible and searchable from within or outside said healthcare record bank; and
a data logging unit operatively connected to said healthcare record bank, wherein said data logging unit maintains metadata associated with said data and facilitates natural language processing (NLP) capabilities of said metadata.

2. The system of claim 1, wherein said proxy database interacts with said clinical data provider through one or more proxy objects, wherein said one or more proxy objects comprising one or more references to said proxy database to establish a connection between said clinical data provider and said proxy database through one or more database drivers, and wherein said one or more database drivers comprising a Java Database Connectivity and Open Database Connectivity (JDBC-ODBC) Driver.

3. The system of claim 1, wherein said content based router forms a communicative link between any of:
said clinical data provider, wherein said clinical data provider comprises a first clinical data provider, and a second clinical data provider; and
said clinical data provider and said healthcare record bank.

4. The system of claim 1, further comprising a social network platform operatively connected to said content based router, wherein said social network platform is external to said healthcare record bank and accesses said metadata stored within said data logging unit.

5. The system of claim 4, wherein said content based router is operatively connected to said healthcare record bank, and wherein said social network platform is operatively connected to said healthcare record bank.

6. The system of claim 1, further comprising a processing component that:
accesses said metadata stored within said data logging unit; and
searches for said metadata using said NLP capabilities,
wherein said healthcare record bank interacts with a metadata management service that facilitates said NLP capabilities.

7. The system of claim 1, wherein said content based router comprises an HL7 content based router that:
collects said data from said proxy database; and
converts said data into a format in accordance with an HL7 standard.

8. The system of claim 1, wherein said proxy database is maintained at any of:
a clinical data provider end that remotely communicates with said healthcare data bank; and
a healthcare record bank end that remotely communicates and retrieves data from said clinical data provider.

9. A system for managing data in a healthcare environment, said system comprising:
a content based router that:
collects data from a clinical data provider; and
converts said data into a format in accordance with a defined standard;
a data repository operatively connected to said content based router;
a healthcare record bank operatively connected to said data repository, wherein said healthcare record bank is operatively connected to said clinical data provider through said content based router over a communication network, and wherein said healthcare record bank stores said data received from said clinical data provider and is accessible and searchable from within or outside said healthcare record bank; and
a data logging unit operatively connected to said healthcare record bank, wherein said data logging unit maintains metadata associated with said data and facilitates natural language processing (NLP) capabilities of said metadata.

10. The system of claim 9, further comprising a proxy database that creates a backup of data associated with said clinical data provider.

11. The system of claim 10, wherein said proxy database interacts with said clinical data provider through one or more proxy objects, wherein said one or more proxy objects comprising one or more references to said proxy database to establish a connection between said clinical data provider and said proxy database through one or more database drivers, and wherein said one or more database drivers comprising a Java Database Connectivity and Open Database Connectivity (JDBC-ODBC) Driver.

12. A method for managing data in a healthcare environment, said method comprising:
creating a backup of data associated with a clinical data provider in a proxy database;
using a content based router to:
collect said data from the proxy database; and
convert said data into a format in accordance with a defined standard;
maintaining metadata associated with said data in a data logging unit; and
providing natural language processing (NLP) capabilities for searching said metadata.

13. The method of claim 12, further comprising storing said data received from said clinical data provider in a healthcare record bank, wherein said data is accessible and searchable from within or outside said healthcare record bank.

14. The method of claim 12, further comprising:
receiving said data from said clinical data provider by said proxy database; and
establishing a connection between said clinical data provider and said proxy database through one or more proxy objects.

15. The method of claim 14, wherein said proxy database is maintained at any of:
a clinical data provider end that remotely communicates with a healthcare data bank; and
a healthcare record bank end that remotely communicates and retrieves data from said clinical data provider.

16. A non-transitory program storage device readable by computer, and comprising a program of instructions executable by said computer to perform a method for managing data in a healthcare environment, said method comprising:
creating a backup of data associated with a clinical data provider in a proxy database;
collecting said data from the proxy database;
converting said data into a format in accordance with a defined standard;
maintaining metadata associated with said data in a data logging unit; and
providing natural language processing (NLP) capabilities for searching said metadata.

17. The program storage device of claim 16, wherein said method further comprises storing said data received from said clinical data provider in a healthcare record bank, wherein said data is accessible and searchable from within or outside said healthcare record bank.

18. The program storage device of claim 16, wherein said method further comprises:
receiving said data from said clinical data provider by said proxy database; and
establishing a connection between said clinical data provider and said proxy database through one or more proxy objects.

19. The program storage device of claim 18, wherein said proxy database is maintained at any of:
a clinical data provider end that remotely communicates with a healthcare data bank; and
a healthcare record bank end that remotely communicates and retrieves data from said clinical data provider.
